(19) United States
(12) Patent Application Publication
(10) Pub. No.: US 2025/0196166 A1
(43) Pub. Date: Jun. 19, 2025

(54) NOZZLE MODULE, SUBSTRATE CLEANING DEVICE AND, SUBSTRATE CLEANING METHOD USING THE SAME

(71) Applicant: Samsung Electronics Co., Ltd., Suwon-si (KR)

(72) Inventors: YOUNG-HO JOH, Suwon-si (KR); YUNSEOK CHOI, Suwon-si (KR); Dongwon Lee, Suwon-si (KR); JONGHYUK PARK, Suwon-si (KR); JAEHYUN SUNG, Suwon-si (KR); EUNSEOK LEE, Suwon-si (KR)

(21) Appl. No.: 18/894,671

(22) Filed: Sep. 24, 2024

(30) Foreign Application Priority Data
Dec. 19, 2023 (KR) 10-2023-0185965
Jan. 5, 2024 (KR) 10-2024-0002292

(51) Int. Cl. B05B 3/00; B08B 1/12; B08B 1/34; B08B 3/02; B08B 3/08

(52) U.S. Cl. CPC B05B 3/00; B08B 1/12; B08B 1/34; B08B 3/02; B08B 3/08

(57) ABSTRACT

A nozzle module according to an embodiment may include a module body extending in a first direction and configured to be spaced apart from a roller brush by a particular distance, wherein the roller brush is configured to clean a substrate, a spray nozzle configured to spray a chemical on the roller brush, and an adjustable nozzle mount that is coupled to the module body and selectively fixes the spray nozzle in a selectable orientation, wherein the adjustable nozzle mount controls an orientation of the spray nozzle to adjust a spraying angle of the spray nozzle.

### CROSS-REFERENCE TO RELATED APPLICATION

This application claims priority to and the benefit of Korean Patent Application No. 10-2023-0185965 filed in the Korean Intellectual Property Office on Dec. 19, 2023, and Korean Patent Application No. 10-2024-0002292 filed in the Korean Intellectual Property Office on Jan. 5, 2024, the entire contents of which are incorporated herein by reference.

### BACKGROUND OF THE DISCLOSURE

### (a) Field of the Disclosure

The present disclosure relates to a nozzle module, a substrate cleaning apparatus, and a substrate cleaning method using the same.

### (b) Description of the Related Art

A chemical mechanical polishing (CMP or chemical mechanical polishing or planarization) process of a semiconductor is a process of planarizing a wafer surface by using chemical reactions and mechanical forces. It is a highly precise process in which the interaction between slurry polishing particles and the wafer surface and the role of slurry organic additives are important variables. In addition to these variables, mechanical variables such as a rotation speed of a polishing pad and a wafer, a pressure applied to the wafer, and a pattern direction of the pad are important.

After completing the polishing process in a CMP facility, a cleaning process is performed to remove impurities (particles). This cleaning process is a process that removes various impurities, such as foreign substances on the substrate surface, metal impurities, organic contaminants, and unnecessary thin films. The cleaning process may use physical and chemical methods.

A cleaning method using a roller brush may include spraying a chemical such as hydrogen fluoride (HF) on a surface of a substrate placed on a platen and brushing the substrate surface with the roller brush in contact with the substrate surface to remove the impurities.

However, in the process of spraying the chemical directly on the surface of the substrate, there is a difference in a spray distance (e.g., the distance between the spray nozzle and a point on the substrate) of the chemical depending on the arrangement position of a nozzle spraying the chemical and the substrate. This may cause a problem in which a large deviation in an etch rate occurs between a substrate region placed close to the nozzle and a substrate region placed far from the nozzle.

In addition, as film materials with a high etching amount are recently used in the CMP processes, the problem may be more pronounced as the etch rate caused by the chemicals becomes significantly higher than before.

Accordingly, it would be beneficial to have a technology to improve an etching uniformity by finely controlling the etch rate by the chemicals in the cleaning process (a post cleaning) that follows the polishing process.

### SUMMARY OF THE DISCLOSURE

Embodiments of the present disclosure address the above problems by way of a spraying angle of a spray nozzle that sprays the chemical is adjusted through an adjustable nozzle mount to ensure that the chemical is evenly applied to the surface of a nodule placed on the roller brush. Through this, a nozzle module, a substrate cleaning apparatus, and a substrate cleaning method using the same are provided to improve the etching uniformity by minimizing the deviation of the etch rate that occurs depending on the substrate region in the process of spraying the chemicals directly on the substrate in conventional.

In addition, a nozzle module, a substrate cleaning apparatus, and a substrate cleaning method using the same, which may maintain the same equipment performance, are provided by fixing the spraying angle of the spray nozzle through the adjustable nozzle mount to maintain the same profile even during a frequent replacement of the roller brush, which is a consumable product.

A nozzle module according to an embodiment may include a module body extending in a first direction and configured to be spaced apart from a roller brush by a particular distance, wherein the roller brush is configured to clean a substrate, a spray nozzle configured to spray a chemical on the roller brush, and an adjustable nozzle mount that is coupled to the module body and selectively fixes the spray nozzle in a selectable orientation, wherein the adjustable nozzle mount controls an orientation of the spray nozzle to adjust a spraying angle of the spray nozzle.

A substrate cleaning apparatus according to an embodiment may include a pair of roller brushes that are each spaced apart from one another by a distance greater than a thickness of a substrate to be cleaned, a pair of nozzle modules spaced apart from one another with the pair of roller brushes therebetween, each of the nozzle modules configured to spray a chemical onto an adjacent roller brush of the pair, and a rinse spray nozzle configured to spray a rinse solution towards a plane between the pair of roller brushes.

A method for manufacturing a semiconductor device according to an embodiment may include spraying a rinse solution on a surface of a substrate, spraying a chemical on a roller brush by a nozzle module arranged side by side with the roller brush and spaced from the roller brush by a certain distance, rotating the roller brush about an axis parallel to a length direction of the roller brush so that the chemical is applied to a plurality of nodules arranged on a surface of the roller brush, cleaning the surface of the substrate by moving the roller brush to be close to the surface of the substrate, and performing a subsequent semiconductor fabrication process to obtain the semiconductor device.

According to embodiments, by adjusting the angle of the nozzle of the spray nozzle that sprays the chemical on the roller brush, the chemical may be applied thinly and evenly to the roller brush, so that a deviation of an etch rate may be minimized, and then an etching uniformity may be improved.

### BRIEF DESCRIPTION OF THE DRAWINGS

FIG. 1 is a view showing a conventional chemical injection device used in a cleaning process (a post cleaning) that is performed after a polishing process in a CMP process.

FIG. 2 is a view showing a conventional chemical injection device used in a cleaning process (a post cleaning) that is performed after a polishing process in a CMP process.

FIG. 3 is a view showing a conventional chemical injection device used in a cleaning process (a post cleaning) that is performed after a polishing process in a CMP process.

FIG. 4 is a view illustrating a nozzle module according to an embodiment.

FIG. 5 is a view illustrating a nozzle module according to another embodiment.

FIG. 6 is a view illustrating a nozzle module according to another embodiment.

FIG. 7 is a view illustrating a nozzle module according to another embodiment.

FIG. 8 is a view illustrating a nozzle module according to another embodiment.

FIG. 9 is a view illustrating a nozzle module according to another embodiment.

FIG. 10 is a view illustrating an adjustable nozzle mount in a nozzle module according to an embodiment.

FIG. 11 is a view illustrating a process of controlling a spraying angle through a first nozzle portion in a nozzle module according to an embodiment.

FIG. 12 is a view illustrating across-section of an interior of a nozzle module according to an embodiment.

FIG. 13 is a view sequentially illustrating a process of adjusting a spraying angle of a nozzle module according to an embodiment.

FIG. 14 is a view illustrating a process of controlling a spraying angle by a rotation of a second nozzle portion and a nozzle coupling in a nozzle module according to an embodiment.

FIG. 15 is a view illustrating a configuration of a substrate cleaning apparatus according to an embodiment.

FIG. 16 is a flow chart illustrating a method for manufacturing a semiconductor device.

### DETAILED DESCRIPTION OF THE EMBODIMENTS

Hereinafter, examples of the present invention will be described in detail with reference to the attached drawings so that the person of ordinary skill in the art may easily implement the present invention. As those skilled in the art would realize, the described embodiments may be modified in various ways, all without departing from the spirit or scope of the present invention. The invention may be embodied in many different forms and should not be construed as limited to the example embodiments set forth herein. These example embodiments are just that—examples—and many implementations and variations are possible that do not require the details provided herein. It should also be emphasized that the disclosure provides details of alternative examples, but such listing of alternatives is not exhaustive. Furthermore, any consistency of detail between various examples should not be interpreted as requiring such detail—it is impracticable to list every possible variation for every feature described herein. The language of the claims should be referenced in determining the requirements of the invention.

Parts that are unrelated to the description of the embodiments may not be shown to make the description clear and like reference numerals designate like elements throughout the specification.

The size and thickness of the configurations are shown in the drawings for convenience of description, and the present invention is not limited to embodiments shown in the drawings. In the drawings, the thickness of layers, films, panels, regions, etc., may be exaggerated for clarity. Further, in the drawings, the thickness of layers and regions may be partially exaggerated for better understanding and ease of description.

In addition, unless explicitly described to the contrary, the word “comprise,” and variations such as “comprises” or “comprising,” will be understood to imply the inclusion of stated elements but not the exclusion of any other elements.

It will be understood that when an element such as a layer, film, region, or substrate is referred to as being “on,” “connected to,” or “coupled to” another element, it can be directly on, directly connected to, or coupled to the other element, or intervening elements may also be present. In contrast, when an element is referred to as being “directly on,” “directly connected to,” “directly coupled to,” or “contacting” another element, there are no intervening elements present. As used herein, items described as being “electrically connected” are configured such that an electrical signal can be passed from one item to the other. Further, in the specification, the word “on” or “above” means positioned on or below the object portion and does not necessarily mean positioned on the upper side of the object portion based on a gravitational direction.

Further, in the specification, the phrase “on a plane” means viewing the object portion from the top, and the phrase “on a cross-section” means viewing a cross-section of which the object portion is vertically cut from the side.

A general CMP process includes a polishing process consisting of a physical polishing of a substrate surface positioned between a head and a polishing pad and a chemical polishing using an abrasive (a slurry). After the polishing process, a cleaning process (a post cleaning) is performed to remove abrasives from the substrate surface. In the cleaning process (the post cleaning) that occurs after the polishing process in the CMP process, the cleaning chemicals may etch the substrate surface and control of an etch rate of the cleaning chemicals may be required. It should be understood that a “substrate” in this application may be the initial substrate that is then processed to manufacture a semiconductor device (e.g., a bulk silicon substrate, a silicon on insulator (SOI) substrate, etc.) or it may be a later formed (e.g., intermediate) product produced during the manufacture of a semiconductor device, which may include such an initial substrate with additional layers formed thereon.

In the cleaning process (the post cleaning) that takes place after the polishing process, a chemical such as HF and a rinse liquid are sprayed on the substrate surface and impurities such as particles are removed by physically rubbing the substrate with a roller brush.

A technology previously used as a cleaning process (a post cleaning) conducted after the polishing process uses a method of spraying an etching chemical directly on the substrate surface to apply the etching chemical. When the etching chemical is sprayed directly on the substrate, particularly when there is material with a high etching amount, it may be difficult to control the uniformity of the etching. To compensate, a dilution device may be installed inside a facility to dilute the etching chemical sprayed on the substrate surface to reduce the etch rate and thereby increase the uniformity of the etching.

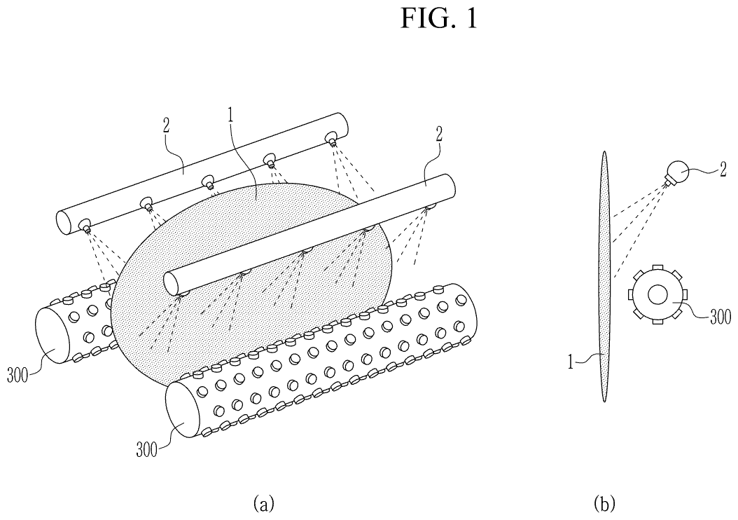

First, FIG. 1 to FIG. 3 are views illustrating a conventional cleaning process (a post cleaning) that is performed after a polishing process in a CMP process.

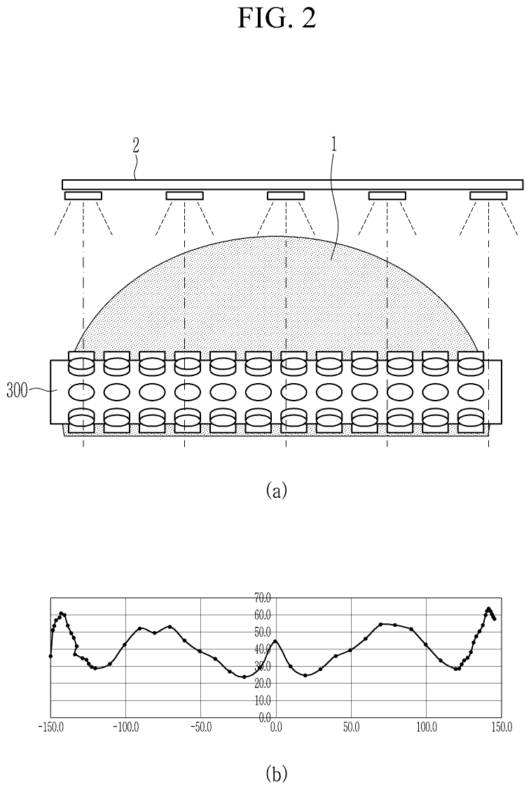

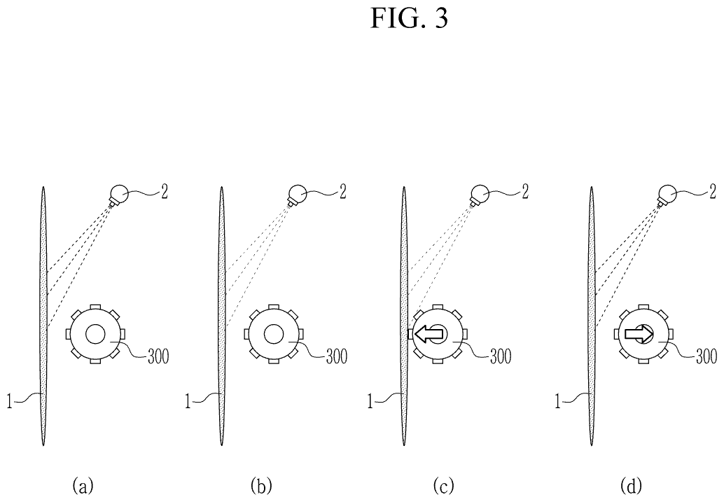

FIG. 1 illustrates a conventional chemical injection device used in the CMP process. FIG. 2 illustrates a conventional chemical injection device and is used to explain a problem of the conventional chemical injection device used in the CMP process. FIG. 3 a conventional chemical injection device and is used to illustrate a process of using the conventional chemical injection device used in the CMP process.

Referring to FIG. 1(a), in the conventional cleaning process of a substrate 1, chemical injection devices 2, which are placed with a chemical injection device 2 positioned over one surface of the substrate 1 and another chemical injection device positioned over an opposing surface of the substrate, sprays a chemical toward the opposing surfaces of the substrate 1 to coat the opposing surfaces of the substrate 1 with the chemical. The substrate 1 that is coated with the chemical is cleaned by roller brushes 300 with a roller brush 300 respectively placed close to a respective one of the opposing surfaces of the substrate 1.

FIG. 1(b) is a view illustrating a cross-section of one of the chemical injection devices 2 and one of the roller brushes 300 positioned over one surface of the substrate 1 in FIG. 1(a)., The cross-sectional view will be used to explain the arrangement relationship of the substrate 1, the roller brush 300, and the injection device 2 on one side of the substrate.

As shown, the injection device 2, which injects the chemical onto the substrate 1, is not placed in the center of the substrate 1 but is positioned toward one side off the center and is arranged to be spaced a fixed distance away from the substrate 1. Accordingly, the distances from the injection device 2 to all regions of the substrate 1 are different. Additionally, the angle formed by the path of the chemical sprayed from the injection device 2 and the surface of the substrate 1, which may be referred to as the spray angle, the amount of chemical sprayed on a given area, and the spray pressure are also different for a given area of the substrate. As explained previously, because the spray angle and distance is different for each area of the substrate, it is difficult to spray the chemical from injection device 2 so as to be evenly applied to the surface of the substrate 1.

FIG. 2(a) is a side view showing a conventional chemical injection device 2 spraying a chemical directly toward a substrate 1, where “directly” indicates that the spray contacts the substrate directly without contacting any other elements first, although the spray may be at an angle relative to the surface of the substrate. FIG. 2(b) is a graph showing a deviation of an etch rate for the substrate 1 when spraying the chemicals as shown in FIG. 2(a).

As shown in FIG. 2(a) and FIG. 2(b), it may be seen that the etch rate varies on the surface of the substrate 1 depending on the position of the area on the substrate 1 being observed. This is because the distance traveled and the angle at which the chemical sprayed from injection device 2 reaches the substrate 1 are different for each area.

As a result, in the case of the conventional injection device 2, which injects a chemical as shown in FIG. 1(a), there is a problem where a large deviation in the etch rate is generated between a region of the substrate 1 that is close to the position where the chemical is sprayed from the injection device 2 and a region of the substrate 1 that is far away from the position where the chemical is sprayed from the injection device 2.

FIG. 3 is a cross section view corresponding to FIG. 1(a) showing sequential states of a conventional injection device 2 and roller brush 300 during a cleaning process to explain a conventional cleaning process (a post cleaning). In the conventional art, as shown in FIG. 3(a), a de-ionized water (DIW) rinse liquid is sprayed from an injection device 2, and then, as shown in FIG. 3(b), a chemical is sprayed directly onto a substrate 1 from the injection device 2. Then, as shown in FIG. 3(c), the roller brush 300 moves close to the substrate 1 and cleans the substrate 1 by the rotation of the roller brush 300. After the cleaning by the roller brush 300 is completed, as shown in FIG. 3(d), the roller brush 300 moves to an original position thereof to be away from the substrate 1 by a certain distance, and the injection device 2 sprays the DIW as a rinse solution toward the substrate 1.

When a chemical with a high etch rate is directly sprayed onto the substrate 1, there may be a problem in that it is difficult to control the etching uniformity, so a dilution device may be needed to dilute the chemicals. However, even when the chemical is diluted, it may still be difficult to evenly apply the chemical to the substrate 1.

The present disclosure provides examples of technologies including a nozzle module 100, a substrate cleaning apparatus 10, and a substrate cleaning method using the same to efficiently control the etch rate of films sensitive to etching chemicals during the cleaning process (the post cleaning) performed after the polishing process described above.

In the substrate cleaning method using the nozzle module 100 and the substrate cleaning apparatus 10 according to the present disclosure, the chemical may be sprayed on the roller brush 300 rather than the substrate 1 (e.g., not directly at the substrate 1) during the cleaning process (the post cleaning) performed after the polishing process and may thereby not need to include a separate dilution device. The use of the method, the nozzle module 100, and/or the substrate cleaning apparatus may improve the etching uniformity by finely controlling the etch rate by applying the chemical evenly and thinly to the roller brush 300. The application of the chemical may be controlled by adjusting the spraying angle at which the chemical is sprayed.

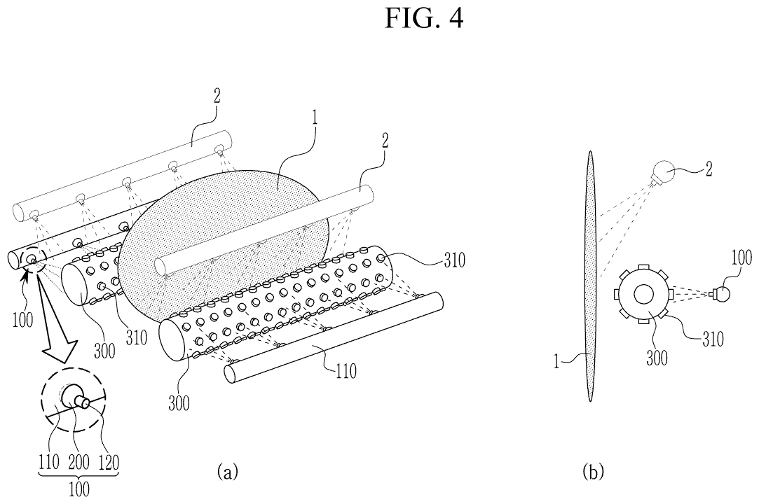

Hereinafter, the nozzle module 100, the substrate cleaning apparatus 10, and the substrate cleaning method using the same according to the present disclosure are described in detail with reference to FIGS. 4 to 14.

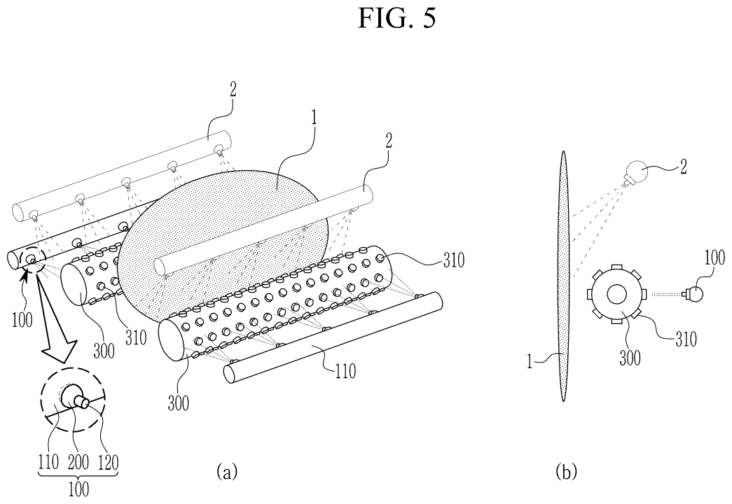

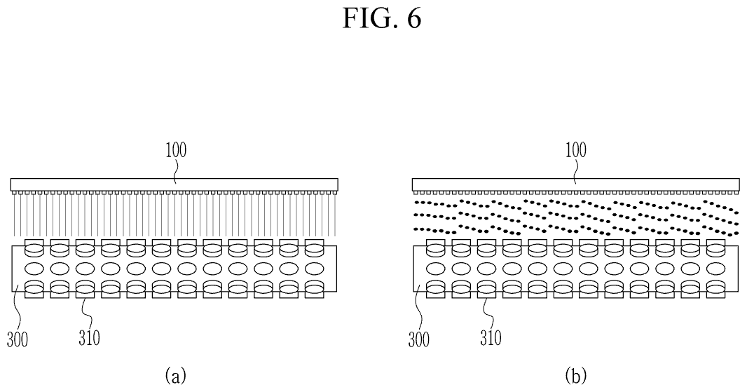

FIG. 4(a) is a perspective view and FIG. 4(b) is a cross-sectional view illustrating a nozzle module according to an embodiment. FIG. 5(a) is a perspective view, FIG. 5(b) is a cross-sectional view, and FIGS. 6(a) and 6(b) are side views illustrating the operation of the nozzle module 100 according to an embodiment.

As shown in FIG. 4(a) and FIG. 5(a), the nozzle module 100 according to the present disclosure may include module bodies 110 that are arranged side by side at a certain distance from an object that cleans the substrate 1, spray nozzles 120, which are disposed on a module body 110 and spray the chemical on the object, and an adjustable nozzle mount 200 that is combined with the spray nozzle 120 and controls the spraying angle of the spray nozzle 120.

A representative example of the object is a roller brush 300. Hereinafter, the object will be described as the roller brush 300.

As used herein, the singular forms “a”, “an” and “the” are intended to include the plural forms as well, unless the context clearly indicates otherwise. Similarly, the plural forms are intended to include the singular forms as well, unless the context clearly indicates otherwise. For example, when describing a single spray nozzle 120, it will be understood that the description is applicable to other spray nozzles 120 as well. Additionally, although a single element may be identified, it will be understood that in some embodiments the single element may be part of a plurality of like elements. As used herein, the term “and/or” includes any and all combinations of one or more of the associated listed items and may be abbreviated as “/”.

The module bodies 110 may have an elongated shape extending lengthwise in a first direction. An item described as extending “lengthwise” in a particular direction has a length in the particular direction and a width perpendicular to that direction, where the length is greater than the width. In some examples, the module bodies may have a round cross section, but embodiments are not limited thereto. The module bodies may have an internal passage extending in the first direction. The internal passage may have an inlet configured to receive a supply of the chemical.

Each of the spray nozzles 120 may be in fluid communication with the internal passage of the module body, such that the chemical supplied to the module body may flow through the internal passage and be expelled from a spray nozzle 120. The adjustable nozzle mount 200 may be a joint coupling a spray nozzle 120 to a module body 110. The position of the spray nozzle relative to the module body may determine the spraying angle of the spray nozzle.

In the present disclosure, the spray angle of the spray nozzle 120 refers to the angle between the direction the spray nozzle 120 is directed to and the roller brush 300, a cone angle is the angle of a cone of the spray exiting the spray nozzle 120, and a stream angle is the angle of an individual stream of fluid exiting the spray nozzle 120. In some embodiments, the spray may not have a conical shape and may have a straight stream in which every stream may be directed in the spray angle, a fan spray in which the spray is planar and has a fan angle the plane, or a mist spray in which there are not individual streams but instead fine droplets that form a mist exiting the spray nozzle 120. Other shapes of the stream are possible. A spraying angle may refer to the general direction that the stream is directed to and is dependent on the spray angle and the distribution of the spray which is dependent on the shape of the spray, such as a cone shape, fan shape, or other shape.

The spray nozzle 120 located on the nozzle module 100 according to the present disclosure may be rotated around an axis extending in the first direction, which is the length direction of the module body 110, and may also be rotated around a second direction that may be perpendicular to the first direction. The adjustable nozzle mount 200 may control the spray nozzle 120 to rotate in the above two-axis directions, thereby controlling the direction in which the chemical sprayed through the spray nozzle 120 is directed. Thus, the adjustable nozzle mount 200 may control the direction in which the chemical is sprayed by controlling the direction in which the spray nozzle 120 is oriented.

Additionally, the combination of the adjustable nozzle mount 200 and the spray nozzle 120 may control the shape of the spray, such as a cone angle at which the chemical is sprayed out of the spray nozzle. The adjustable nozzle mount 200 and the spray nozzle may also control a way that the chemical is sprayed. This will be described with reference to FIG. 4, FIG. 5, and FIG. 6.

The spray nozzles 120 may be arranged on the module body 110 along the length direction of the module body 110. The adjustable nozzle mount 200 may be located between the spray nozzle 120 and the module body 110 (e.g., the adjustable nozzle mount 200 may couple the spray nozzle 120 to the module body). The spacing between each of the spray nozzles 120 on the module body 110 may be at fixed intervals which may be selected to achieve an even distribution of the spray.

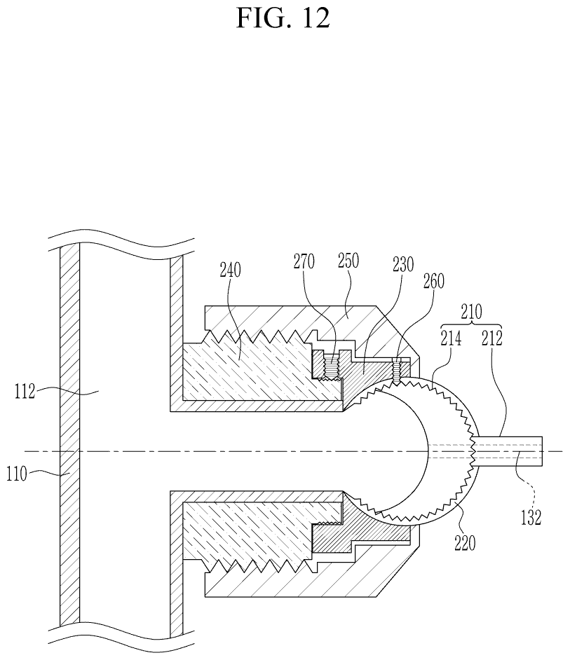

FIG. 4(a) and FIG. 5(a) show that the adjustable nozzle mount 200 is connected to the module body 110 and the spray nozzle 120, but the configuration indicated by the spray nozzle 120 in FIG. 4(a) and FIG. 5(a) substantially corresponds to the nozzle 212 of FIG. 12 and other figures.

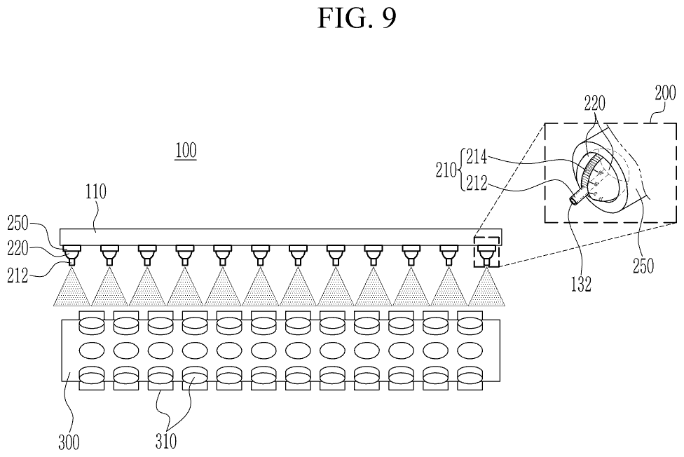

The spray nozzle 120 according to the present disclosure may be located partially within the adjustable nozzle mount 200 and may include a nozzle 212 protruding from the adjustable nozzle mount 200 with a discharging path 132 passing through the spray nozzle 120 from an end within the adjustable nozzle mount 200 and continuing to the nozzle 212 as shown in FIG. 9 to FIG. 14 below. However, in FIG. 4(a) and FIG. 5(a), the nozzle 212 was not shown. For simplicity in illustrating that the adjustable nozzle mount 200 adjusts the angle of the spray nozzle 120, only the nozzle 212 protruding from the adjustable nozzle mount 200 is indicated as the spray nozzle 120.

Each of the adjustable nozzle mounts 200 combined with each of the plurality of spray nozzles 120 may independently control the spraying angle of the chemical sprayed from the spray nozzles 120.

According to the present disclosure, the nozzle module 100 sprays the chemical on the roller brush 300 through each spray nozzle 120, which may be positioned close to a roller brush 300 that is located on or over one of the opposing surfaces of the substrate 1. The spraying angle at which the chemical is sprayed from the spray nozzle 120 may be adjusted with the adjustable nozzle mount 200 to evenly and thinly apply the chemical to the roller brush 300. By adjusting the spraying angle with the adjustable nozzle mount 200, the chemical can be sprayed on the roller brush to coat the roller brush surface thinly and evenly. The roller brush may have a plurality of nodules 310 with flat surfaces (e.g., brushes). The nodules 310 may be disposed on the surface of the roller brush 300. When the roller brush 300 moves closer to the substrate 1 (e.g., moved toward the substrate by a roller brush actuator) and rotates against the substrate 1 (e.g., rotated by a roller brush rotator), the plurality of nodules 310 come into contact with the substrate 1 multiple times as the brush rotates and the substrate 1 is cleaned with the roller brush 300 while applying the chemical sprayed onto the roller brush 300 to the substrate 1.

When using the nozzle module 100 according to the present disclosure, the flat surface of the nodules 310 of the roller brush 300 slowly and evenly apply the chemical to the substrate 1 as they contact the substrate 1. Because the chemical is slowly and evenly applied to the substrate 1, there is no need for a separate device to dilute the chemical.

FIG. 4(b) and FIG. 5(b) are drawings of side views used to describe the appearance or format of the spray of the chemical sprayed from nozzle module 100 and directed to the flat surface of the nodule 310 of the roller brush 300. The drawings show the substrate 1, the roller brush 300, and the nozzle module 100 viewed from the side.

The chemical sprayed from the spray nozzle 120 may be sprayed on the flat surface of the nodule 310 of the roller brush 300 in various ways. FIG.4(b) shows an embodiment in which the chemical is sprayed with a cone format in which some chemical streams are sprayed diagonally at a certain angle toward the roller brush 300, and FIG. 5(b) shows an embodiment in which the chemical is sprayed in a narrow or flat stream on the roller brush 300, (e.g., with a low cone angle, such as less than 5 degrees, or no cone angle).

The method of spraying the chemical from the spray nozzle 120 may be controlled by the adjustable nozzle mount 200 by adjusting the size and shape of cross-section of a discharge hole (not shown) through which the chemical is discharged through the spray nozzle 120. When the entire discharge hole forms one region (e.g., is unobstructed), the chemical sprayed through the discharge hole may be sprayed in a narrow stream on the roller brush 300 as shown in FIG. 5(b). When a part of the discharge hole is blocked or the discharge hole is divided into a plurality of regions, as the area of the discharge hole is different, the path and direction of the chemical sprayed through the discharge hole changes. The spraying method of the sprayed chemical may be adjusted by variously changing the cross-section of the discharge hole. The discharge hole above refers to a hole at the exit of the discharging path 132 of the discharging path 132 of the spray nozzle 120. Although not shown in detail in FIG. 4 and FIG. 5, this is shown in detail in FIG. 12.

In addition to controlling the cross-section of the discharge hole, the adjustable nozzle mount 200 of the nozzle module 100 according to the present disclosure may adjust the angle toward which the spray nozzle 120 is directed (i.e., the spray angle) so that the angle that the sprayed chemical is directed may be adjusted.

As shown in FIG. 4 and FIG. 5, the nozzle module 100 according to the present disclosure may be implemented together with the conventional injection device 2 (rinse spray nozzle) described in FIG. 1 to FIG. 3. However, unlike the injection device 2 in FIG. 3(b) and FIG. 3(c) which sprays the chemical on the substrate 1, the injection device 2 shown with the nozzle module 100 in FIG. 4 and FIG. 5 is configured differently in that it sprays only the DIW on the substrate 1 as a rinse solution. When using the nozzle module 100 according to the present disclosure, there is no need to spray the chemical in the conventional injection device 2 because the chemical is sprayed from the nozzle module 100 on the roller brush 300.

FIG. 6 is a drawing for describing various spraying methods in which the chemical is sprayed from the spray nozzle 120, and FIG. 6(a), as shown in FIG. 5(b), is an embodiment that sprays the chemical vertically in a straight line without any inclination (e.g., with a narrow cone angle or in a straight spray). FIG. 6(b) is an embodiment that sprays the chemical as a mist. As described above, the spraying method of the chemical may be adjusted by changing the cross-section shape of the discharge hole through which the chemical is sprayed (specifically, the hole of the discharging path 132 of the spray nozzle 120).

In the present disclosure, the chemical may include HF, NH4OH, SC1 (a mixture of DIW, H2O2, and NH4OH). However, the present disclosure is not limited to the chemicals listed above and may include all chemicals available in the cleaning process performed during the CMP process.

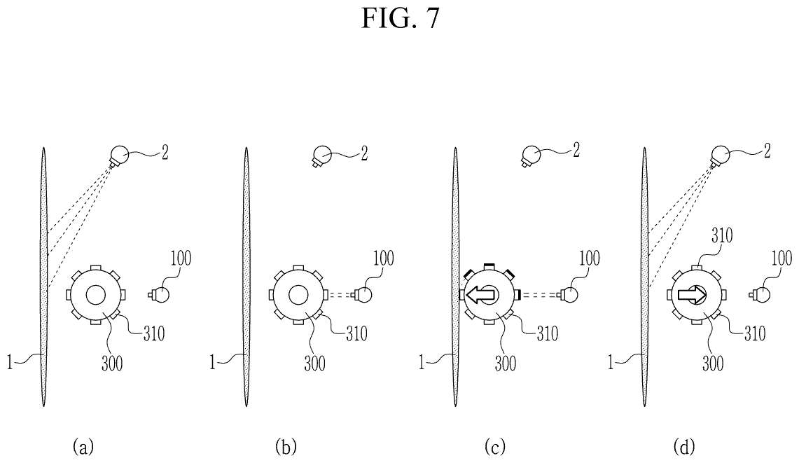

FIG. 7 is a drawing illustrating a nozzle module according to another embodiment. FIG. 7 shows the cleaning process (the post cleaning) that is performed after the polishing process during the CMP process. In the embodiment of FIG. 7, the conventional injection device 2 described in FIG. 1 to FIG. 3 may be implemented together with the nozzle module 100.

However, as shown in FIG. 4 and FIG. 5, the role of the injection device 2 is different from the conventional use. That is, in the conventional used described in FIG. 3(a) and FIG. 3(d), the injection device 2 sprayed the DIW as a rinse solution on the substrate 1, and in FIG. 3(b) and FIG. 3(c), the injection device 2 sprayed the chemical on the substrate 1. In contrast, the injection device 2 shown in FIG. 7 does not spray the chemical and only DIW is sprayed on the substrate 1 in FIG. 7(a) and FIG. 7(d). When using the nozzle module 100 according to the present disclosure, there is no need to spray the chemical in the conventional injection device 2 because the chemical is sprayed from the nozzle module 100 to the roller brush 300.

As shown in FIG. 7(a), the injection device 2 sprays the DIW as the rinse liquid onto the substrate. Next, as shown in FIG. 7(b), the chemical is sprayed from the nozzle module 100 on the flat surface of the nodule 310 of the roller brush 300. Then, as shown in FIG. 7(c), the roller brush 300 moves closer to the substrate 1 and the roller brush 300 rotates causing the plurality of nodule 310 surfaces to come into contact with the substrate 1 several times, The substrate 1 is cleaned by the roller brush 300 while evenly coating the chemical on the substrate 1. In the embodiment of FIG. 7(c), there is no need to spray the DIW on the substrate 1 under the roller brush 300. After the cleaning of the substrate 1 by the roller brush 300 is completed, the roller brush 300 moves to an original position thereof to be away from substrate 1 by a certain distance as shown in FIG. 7(d), and the injection device 2 sprays the DIW as a rinse solution toward the substrate 1.

As shown in FIG. 7(a) to FIG. 7(d), the nozzle module 100, which is arranged side by side at a certain distance from the roller brush 300 that cleans the substrate 1, sprays the chemical on the roller brush 300 and not on the substrate 1.

Particularly, a technical feature is that the chemical is evenly applied to the surface of the nodule 310 on the roller brush 300. The adjustable nozzle mount 200 may adjust the spraying angle of the spray nozzle 120 to a first spraying angle so that the chemical is evenly applied to the surface of the nodule 310 placed on the roller brush 300.

The first spraying angle above refers to the angle at which the spray nozzle 120 is directed so that the chemical may be evenly applied to the surface of the nodule 310 of the roller brush 300 from the spray nozzle 120. The first spraying angle may be selected dependent on diameter of the roller brush 300, the distance between the spray nozzle 120 and the roller brush, and the chemical being used. For example, the first spraying angle may be selected so that the spray coats a 45 degree portion of the circumference of the roller brush 300, although embodiments are not limited thereto.

In embodiments in which there are multiple spray nozzles 120, the spraying angles at which each spray nozzle 120 may evenly apply the chemical to the nodule 310 surface of roller brush 300 may be different, in this case, the optimal spraying angle of each spray nozzle 120 is collectively defined as the first spraying angle.

The spraying angle of the spray nozzle 120 may be adjusted in the adjustable nozzle mount 200 by rotating the spray nozzle 120 about the first axis that extends in the first direction, which is the length direction of the module body 110, and the second direction, which is perpendicular to the first direction. Additionally, the adjustable nozzle mount 200 may fix the spray nozzle 120 so that it no longer rotates.

The adjustable nozzle mount 200 includes a nozzle coupling 230 that fixes the spray nozzle 120 in a position where the spray nozzle 120 is rotated to with reference to two axes above, and the spray nozzle 120 may be fixed by using the nozzle coupling 230 so that the spray nozzle no longer rotates,

The nozzle coupling 230 includes a first coupler 260 and a second coupler 270. The process for fixing the spray nozzle 120 by the first coupler 260 and the second coupler 270 is described with reference to FIG. 12 to FIG. 14 below.

The adjustable nozzle mount 200 may fix the spraying angle of each spray nozzle 120 with the first spraying angle, which is the optimal spraying angle of each spray nozzle 120 by using the nozzle coupling 230, including the first coupler 260 and the second coupler 270. During the replacement process of the roller brush 300, the nozzle coupling 230 prevents the direction the spray nozzle 120 is oriented from being changed if the nozzle module 100 is touched. Thus, the spray direction of the chemical sprayed toward the roller brush 300 may be repeated.

Specifically, the spray nozzle 120 of the nozzle module 100 that sprays the chemical on the roller brush 300 may be at a state in which the spraying angle of the spray nozzle 120 has been adjusted to the first spraying angle, as described above. When the roller brush 300 is a consumable product, it must be replaced regularly. When the spraying angle set at the first spraying angle to apply the chemical evenly to the roller brush 300 and the roller brush is being replaced, there may be no choice but to touch the nozzle module 100 during the process since the nozzle module 100 may be located close to the roller brush 300. Without the nozzle coupling 230, during the process of changing the roller brush 300, the direction toward which the spray nozzle 120 of the nozzle module 100 is oriented changes. If the direction in which the spray nozzle 120 is oriented changes, the spraying angle of the spray nozzle 120 of the nozzle module 100 may need to be adjusted to the optimized first spraying angle again, resulting in the inconvenience of having to reset the angle.

In the nozzle module 100 according to the present disclosure, the adjustable nozzle mount 200 may fix the spraying angle of the spray nozzle 120 at the first spraying angle, thereby maintaining the optimal spraying angle. In other words, when the adjustable nozzle mount 200 fixes the spraying angle of the spray nozzle 120 at the first spraying angle by using the nozzle coupling 230, the inconvenience of setting the same profile again is eliminated and there is an effect of shortening the time required to set it again.

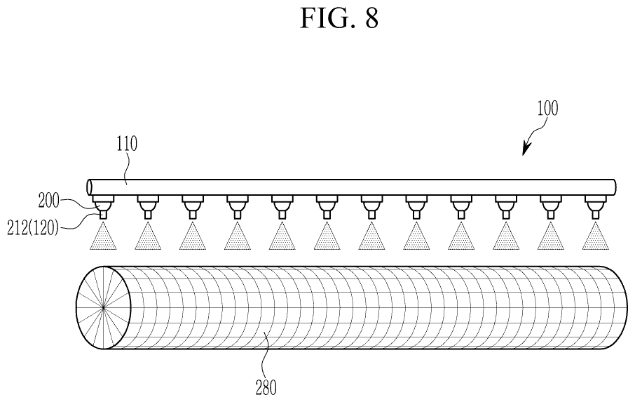

FIG. 8 is a view illustrating a nozzle module according to an embodiment. In FIG. 8, it is shown that the adjustable nozzle mount 200 is located on the module body 110 and the spray nozzle 120 is connected to the module body 110 through the adjustable nozzle mount 200. In FIG. 8, the discharging path 132 inside the spray nozzle 120 is together indicated. In the drawing of FIG. 8, the discharging path 132 inside the spray nozzle 120 is not visible, but when referring to the spray nozzle 120 it will be understood that the reference includes the discharging path 132 inside the nozzle 212 (referring to FIG. 12).

FIG. 8 shows the process in which the adjustable nozzle mount 200 may be used to set the spraying angle of the spray nozzle 120 at the first spraying angle so that the chemical is evenly applied to the surface of the nodule 310 placed on the roller brush 300 and corresponds to FIG. 7(c). That is, FIG. 8 shows the process of finding the first spraying angle, which is the optimal spraying angle to evenly apply the chemical to the nodule 310 surface of the roller brush 300, and the roller brush jig 280 may be used to fine tune the spraying angle. According to the present disclosure, the nozzle module 100 may control the position at which the chemical is sprayed on the roller brush jig 280. The evenness of the coating resulting from the chemical sprayed from the nozzle module 100 may be checked by observing the coating on the roller brush jig 280. If the coating is unsatisfactory, the spraying angle of the spray nozzle 120 of the nozzle module 100 may be adjusted to a specific angle and the coating of the roller brush jig 280 may be checked again. Through the repeated process of adjusting the spray angle, spraying the roller brush jig 280, and checking the coating of the roller brush jig 280, the spraying angle of the spray nozzle 120 may be set to the first spraying angle. In addition, by using the roller brush jig 280, the spraying range of the chemical sprayed on the roller brush jig 280 may be quantitatively measured at the spraying angle which the spray nozzle 120 is set to, and through this, the spraying angle may be quantitatively set.

As shown in FIG. 8, the roller brush jig 280 may be marked with an indicator line to identify the actual position of the nodules 310 of the roller brush 300. The indicator line may be used to check the position the chemicals are applied to by spraying chemicals on the roller brush jig 280. When the spray nozzle 120 sprays the chemical to have a specific spraying angle, by considering the position of the chemical sprayed on the roller brush jig 280, the first spraying angle capable of spraying the chemical so that the chemical is evenly distributed on the nodule 310 of the actual roller brush 300 may be found. In addition, through the spraying process on the roller brush jig 280, it is possible to quantitatively determine whether the spray nozzle 120 sprays the chemical thinly and evenly on the nodule 310 of the roller brush 300 when a certain amount is sprayed on the roller brush 300 for a certain amount of time using the actual spray angle of the spray nozzle 120.

Using the spraying angle, the spraying time, and the spraying amount (a spraying pressure) determined through the use of the roller brush jig 280, the adjustable nozzle mount 200 may be used to adjust the angle at which the spray nozzle 120 is placed. Through this, the chemical may be applied evenly to the nodule 310 surface, and simultaneously, the chemical may be applied thinly to the nodule 310 surface by adjusting the spray time and the spray pressure. Accordingly, the nozzle module 100 according to the present disclosure may control the etch rate by evenly and thinly applying the chemical to the nodule 310 surface and may ultimately improve the uniformity of the substrate 1.

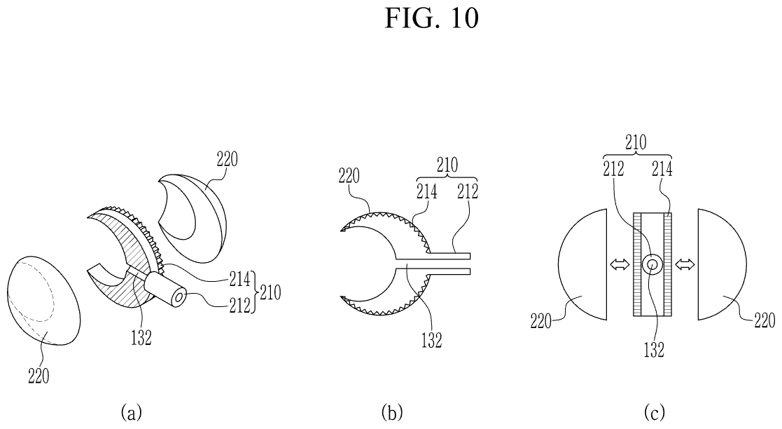

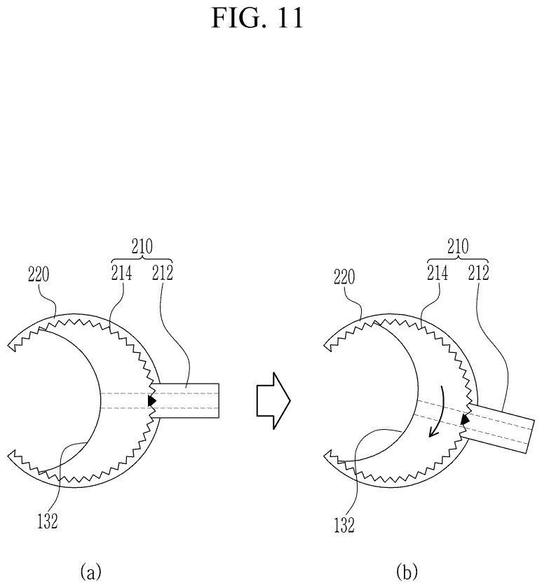

FIG. 9 is a view illustrating a nozzle module according to another embodiment. FIG. 10 is a view illustrating an adjustable nozzle mount in a nozzle module according to an embodiment. FIG. 11 is a view illustrating a process of controlling a spraying angle through a first nozzle portion in a nozzle module according to an embodiment. FIG. 12 is a view showing one cross-section to illustrate an interior of a nozzle module according to an embodiment.

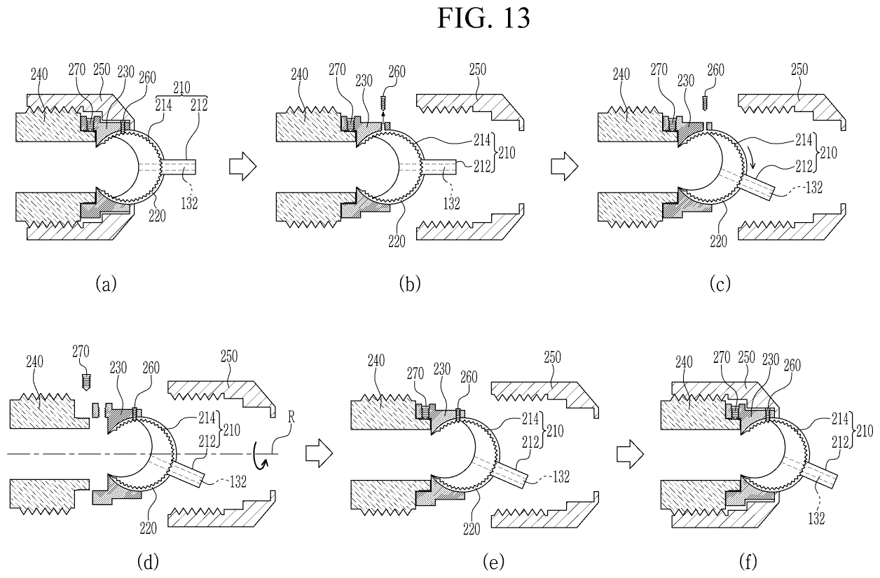

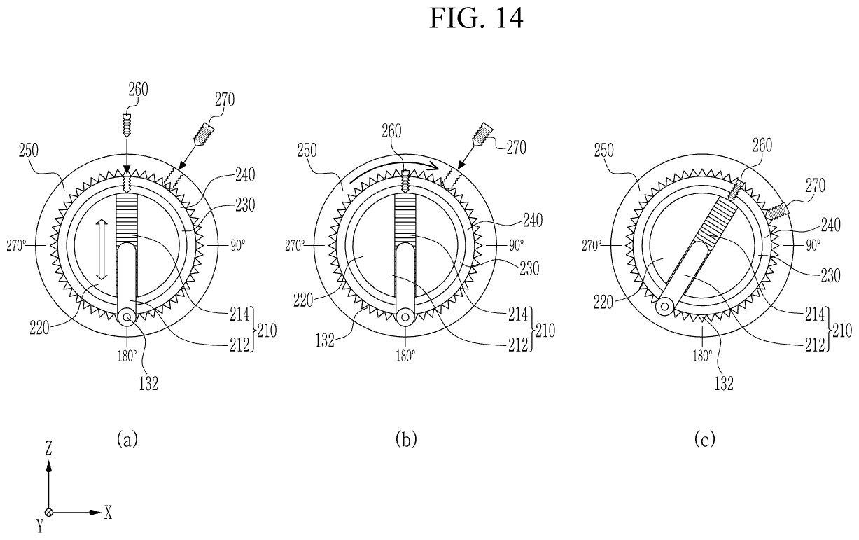

FIG. 13 is a view sequentially showing a process of adjusting a spraying angle of a nozzle module according to an embodiment. FIG. 14 is a view shown to illustrate a process of controlling a spraying angle by a rotation of a second nozzle portion and a nozzle coupling in a nozzle module according to an embodiment.

As shown in FIG. 9 to FIG. 12, the spray nozzle 120 may have a discharging path 132. The discharging path 132 is located inside the nozzle 212 of the first nozzle portion 210. A first end of the discharging path 132 is connected to a flow path 112 (e.g., the internal passage of the module body 110) through which the chemical moves inside the module body 110 moves. A second end of the discharging path 132 exits the nozzle 212 and faces the roller brush 300 so the chemical may be sprayed on the roller brush 300.

By controlling the area and the shape of the cross-section of the second end of the discharging path 132 where the chemical exits the nozzle, the chemical sprayed from the discharging path 132, as shown in FIG. 5 and FIG. 6, may be adjusted into a diagonal (i.e., conical) spray, a straight line spray, or a fog spray (i.e., mist). In addition to the spraying method, the amount of the chemical sprayed at once may be adjusted.

The enlarged portion of the drawing in FIG. 9 shows an external housing 250 of the adjustable nozzle mount 200 and the spray nozzle, which may include the first nozzle portion 210 and the second nozzle portion 220 The external housing 250 may be arranged to surround a portion of the outside of the first nozzle portion 210 and the second nozzle portion 220. The external housing 250 may also connect the first nozzle portion 210 and the second nozzle portion 220 to the module body 110.

A guiding portion 214 of the spray nozzle 120 has a band shape as viewed when secured in the adjustable nozzle mount 200 and may have a generally crescent profile when viewed in isolation. The visible band shape may appear as a circumferential portion (e.g., a central slice) of a spherical shape of the second nozzle portion 220. The guiding portion 214 is a body that is movable along the band shape. Referring to the angle shown in the enlarged portion of the drawing in FIG. 9, the nozzle 212 connected to the guiding portion 214 may be rotated to adjust the direction toward which the nozzle 212 is directed, that is, the spraying angle, according to the movement of the guiding portion 214.

In FIG. 9, the external housing 250 is shown as being directly coupled to the module body 110, but the external housing 250 is not necessarily directly coupled to the module body 110 and other, intervening elements, may be present between the external housing 250 and the module body 110. The external housing 250 may cover an outer part of the first nozzle portion 210 and the second nozzle portion 220, as shown in FIG. 12. The external housing 250 in the present disclosure serves to secure each component placed inside the external housing 250, and a specific structure of each component placed inside the external housing 250 is described with reference to FIG. 10 to FIG. 12.

As shown in FIG. 10 to FIG. 12, in the nozzle module 100 according to the present disclosure, a spray nozzle 120 includes a first nozzle portion 210, a second nozzle portion 220, a nozzle coupling 230, and a connection portion 240. In addition, the adjustable nozzle mount 200 may include a nozzle coupling 230, a connection portion 240, and an external housing 250 surrounding the first nozzle portion 210, the second nozzle portion 220, the nozzle coupling 230, and the connection portion 240. Parts of the first nozzle portion 210 and the second nozzle portion 220 may be exposed from the external housing 250.

FIG. 10(a), (b), and (c) show the combination of the first nozzle portion 210 and the second nozzle portion 220. FIG. 10(a) is a drawing showing the first nozzle portion 210 and the second nozzle portion 220 being separated as seen from the diagonal direction with the nozzle 212 being oriented to a front direction. FIG. 10(b) is a drawing showing the view of FIG. 10(a) from the side. FIG. 10(c) is a drawing showing the view of FIG. 10(a) shown from the front.

As shown in FIG. 10(a), the second nozzle portions 220 are each coupled to opposing sides of the guiding portion 214 so that the nozzle 212 of the first nozzle portion 210 is exposed. The second nozzle portion 220 in the coupled state may have a spherical shape.

The first nozzle portion 210 includes a nozzle 212 in a shape of a tube (i.e., a cylindrical protrusion) through which the discharging path 132 passes and a guiding portion 214 in a shape of a band to which the nozzle 212 may be secured. The guiding portion 214 may be moved along the band circumference relative to the second nozzle portion 220. Since the nozzle 212 is fixed to the guiding portion 214 they move together, thereby adjusting the spraying angle relative to the second nozzle portion 220 and the module body 110.

As shown in FIGS. 10(a), 10(b), and 10(c), the second nozzle portions 220 are coupled on opposing sides of the guiding portion 214 of the first nozzle portion 210, and the hemisphere shapes disposed on both sides of the guiding portion 214 are coupled to the guiding portion 214 to form a spherical shape. A sawtooth pattern may be located along the outer surface of the band shape of the guiding portion 214. The nozzle 212 has a structure that passes through a region of the band shape of the guiding portion 214 and protrudes to the outside. The spray nozzle 120, that is, the discharging path 132, may be located inside the sphere shape formed by the second nozzle portion 220.

FIG. 11 is a drawing illustrating how the nozzle 212 and the guiding portion 214, which together comprise the first nozzle portion 210, move along the band shape of the guiding portion 214 to adjust the direction toward which the nozzle 212 is oriented. The drawing shows the sides of the first nozzle portion 210 and the second nozzle portion 220. As shown in FIGS. 11(a) and 11(b), the second nozzle portion 220, which has the hemisphere shape and is disposed on opposing sides of the guiding portion 214, is fixed in the external housing 250 and maintains the position as it is such that only the guiding portion 214 may rotate along the arrow direction shown. As shown in FIG. 11 (b), since the nozzle 212 fixed to the guiding portion 214, by the rotation of the guiding portion 214, the angle of the discharging path 132 disposed inside the nozzle 212 may be adjusted.

FIG. 12 is a drawing illustrating a cross section of the nozzle module 100. As shown in FIG. 10 to FIG. 12, for the discharging path 132 of the spray nozzle 120, an end may be built into the nozzle 212 and be fixed so that the cross-section of the discharging path 132 faces outside the spray nozzle 120. An opposite end of the discharging path 132 is connected to the flow path 112 disposed inside the module body 110. The discharging path 132 extends to inside the hemisphere shape composed of the second nozzle portion 220 and the guiding portion 214, and the discharging path 132 is disposed inside the nozzle coupling 230 and the connection portion 240.

When adjusting the cross-section of the end of the discharging path 132 inside the nozzle 212 from which chemicals are sprayed or dividing the end of the discharging path 132 into a plurality of regions, as the area of the discharging path 132 where the chemical is sprayed becomes different, the path and the direction of the sprayed chemical may change. Accordingly, in the nozzle module 100 according to the present disclosure, the spraying method of the sprayed chemical may be adjusted by variously changing the cross-section of the end of the discharging path 132 disposed in the nozzle 212.

Referring to FIG. 12, as the end of the discharging path 132 inside the nozzle 212 is fixed to the nozzle 212, when the nozzle 212 and the guiding portion 214, which together compose the first nozzle portion 210, as shown in FIG. 11, move to be rotated, the injection angle of the discharging path 132 disposed inside the nozzle 212 changes with the first nozzle portion 210. The first nozzle portion 210 and the second nozzle portion 220 shown in FIG. 12 are the same as described in FIG. 10 and FIG. 11.

The nozzle coupling 230, as shown in FIG. 12, is coupled to the first nozzle portion 210 and the second nozzle portion 220 and allows for a portion of the first nozzle portion 210 and the second nozzle portion 220 to be exposed from the adjustable nozzle mount 200. The nozzle coupling 230 may be rotated about the rotation axis R shown in FIG. 13(d) in a state that is coupled with the first nozzle portion 210 and the second nozzle portion 220. The rotation of the nozzle coupling 230 is described through FIG. 13(d) and FIG. 14(b).

The connection portion 240 has a first end coupled to the nozzle coupling 230 and a second end opposite to the first end other end coupled to the module body 110 and may have a length in the length direction of the rotation axis (R). As shown in FIG. 12, the connection portion 240 serves to connect the nozzle coupling 230 and the module body 110 with the spray nozzle 120 including the discharging path 132 located therein.

The external housing 250 is arranged to surround the first nozzle portion 210, the second nozzle portion 220, the nozzle coupling 230, and the connection portion 240. The external housing 250 serves to fix the first nozzle portion 210, the second nozzle portion 220, the nozzle coupling 230. As shown in FIG. 12, a threaded surface may be formed on a surface where the inner surface of the external housing 250 and the exterior surface of the connection portion 240 are in contact with each other, and the external housing 250 and the connection portion 240 may be fixed to each other by the coupling between the threaded surfaces.

Also, as shown in FIG. 12, the adjustable nozzle mount 200 may further include a first coupler 260 that fixes the guiding portion 214 to the nozzle coupling 230. The first coupler 260 may be arranged to be coupled to the guiding portion 214 of the first nozzle portion 210 and the nozzle coupling 230. The first coupler 260 is coupled to teeth formed on the guiding portion 214 through the nozzle coupling 230 to prevent the guiding portion 214 from rotating and serves to fix the position of the nozzle 212 by fixing the nozzle coupling 230 and guiding portion 214 together. In some embodiments, the first coupler 260 may be a threaded set screw.

Additionally, the adjustable nozzle mount 200 may further include a second coupler 270 that is arranged to be coupled to the nozzle coupling 230 and the connection portion 240. The second coupler 270 fixes the nozzle coupling 230 to the connection portion 240. The second coupler 270 serves to fix the nozzle coupling 230 to the connection portion 240, which is fixed to the module body 110. In some embodiments, the second coupler may be a threaded set screw.

In the state where the first coupler 260 is coupled, the nozzle coupling 230 may have an internal semi-spherical shape surrounding the second nozzle portion 220 that has a spherical shape which may couple the second nozzle portion 220 in the nozzle coupling 230. As shown in FIG. 13(d), in order to rotate the second nozzle portion 220, the nozzle coupling 230 must be rotated together with the second nozzle portion 220.

Accordingly, as shown in FIG. 12, when both the first coupler 260 and the second coupler 270 are each coupled, since the guiding portion 214 is fixed to the nozzle coupling 230 and the nozzle coupling 230 is fixed to the connection portion 240, the direction toward which nozzle 212 is oriented is fixed. A hole may be formed in the nozzle coupling 230 for the first coupler 260 to pass through. The end of the first coupler 260 coupled to the guiding portion 214 engages with a serrated groove of the guiding portion 214 and may be coupled to the guiding portion 214. Additionally, a hole may be formed in the nozzle coupling 230 for the second coupler 270 to pass through, and the end of the second coupler 270 coupled to the connection portion 240 engages with a serrated groove formed in the connection portion 240, thereby being coupled to the connection portion 240. Each of the holes may have an internal thread for receiving the respective first coupler 260 or second coupler 270.

FIG. 13 is a view of the cross-section of the adjustable nozzle mount 200 and the spray nozzle 120 and illustrates the adjustment process of adjusting the spraying angle by adjusting the first nozzle portion 210 and the adjustment process of the spraying angle by adjusting the rotation of the second nozzle portion 220.

FIG. 13(a), illustrates the first nozzle portion 210 and the second nozzle portion 220 being coupled to the nozzle coupling 230, the connection portion 240, and the external housing 250 by the first coupler 260 and the second coupler 270. The external housing 250 and the connection portion 240 may be coupled with the threads formed on the inner surface of the external housing 250 and the exterior surface of the connection portion 240 engage with each other.

FIG. 13(b) is a drawing illustrating the first coupler 260 that secures the guiding portion 214 to the nozzle coupling 230 being separated. As the first coupler 260 is separated from the sawtooth groove formed in the guiding portion 214, the guiding portion 214 becomes capable of rotation. FIG. 13(c) is a drawing showing the guiding portion 214 rotating along the arrow direction in the state of FIG. 13(b) with the first coupler 260 being separated. The nozzle 212 fixed to the guiding portion 214 may move together with the guiding portion in the direction of the arrow. Thus, as shown, the spraying angle of the spray nozzle 120 disposed inside the nozzle 212, that is, the discharging path 132 that sprays the chemical, may be adjusted. In FIG. 13(c), the spray nozzle 120 rotates around the first direction, which is the length direction of the module body 110.

Here, for the discharging path 132 disposed within the spherical shape formed by the second nozzle portion 220 is fixed with the end in the state that the other end is disposed inside the nozzle 212, and simultaneously, at least one part may be coupled to the inner surface of the guiding portion 214. Accordingly, when the guiding portion 214 rotates as shown in FIG. 13(c), the discharging path 132 coupled to the guiding portion 214 may be rotated together with the guiding portion. Since each hemisphere shape forming the second nozzle portion 220 is fixed to the nozzle coupling 230, it cannot rotate and remains fixed. When the guiding portion 214 rotates along the band shape, the second nozzle portion 220 does not rotate together with the guiding portion 214 (referring to FIG. 10(c)).

In FIG. 13(d), after adjusting the angle at which the discharging path 132 is directed by the rotation of the guiding portion 214 in FIG. 13(c), the first coupler 260 is recoupled to fix the guiding portion 214 to the nozzle coupling 230, thereby fixing the guiding portion 214. FIG. 13(d) is a drawing showing the rotation of the nozzle coupling 230 in the direction of the arrow about the axis R shown in FIG. 13(d) in the state that the nozzle coupling 230 and the connection portion 240 are separated by removing the second coupler 270 fixing the nozzle coupling 230 and the connection portion 240. As shown in FIG. 13(d), when rotating the nozzle coupling 230, the second nozzle portion 220 having the spherical shape fixed to the nozzle coupling 230 rotates with the nozzle coupling 230 about the axis R. In FIG. 13(d), the spray nozzle 120 is a shape that rotates around a second direction perpendicular to the first direction, which is the length direction of the module body 110.

When the second nozzle portion 220 performs the above rotation, as the guiding portion 214 coupled to the second nozzle portion 220 and the nozzle 212 fixed to the guiding portion 214 rotate together, the injection angle of the discharging path 132 disposed inside the nozzle 212 also changes. The angle adjustment of the discharging path 132 according to the rotation of the nozzle coupling 230 in FIG. 13(d) is described in detail with reference to FIG. 14 below.

FIG. 13(e), as shown in FIG. 13(d), shows that after the spaying angle of the discharging path 132 is adjusted by rotating the nozzle coupling 230, the second coupler 270 is recoupled to fix the nozzle coupling 230 and the connection portion 240.

FIG. 13(f) shows the external housing 250 and the connection portion 240 being recoupled, where the threads formed on the inner side of the external housing 250 and the exterior side of the connection portion 240 are engaged.

As sequentially shown in FIG. 13(a) to FIG. 13(f), the discharging path 132, which sprays the chemical in the nozzle module 100 according to the present disclosure, as shown in FIG. 13(c), may adjust the spraying angle by the rotation of the guiding portion 214, as shown in FIG. 13(d), the spraying angle may be adjusted along the rotation of the second nozzle portion 220 due to the rotation of the nozzle coupling 230.

In FIG. 12 and FIG. 13, as a configuration for fixing the first nozzle portion 210, the second nozzle portion 220, the nozzle coupling 230, and the connection portion 240 inside the adjustable nozzle mount 200, and a pin shape that engages the first coupler 260 and the second coupler 270 with each serrated groove is shown. However, the shape and structure of the first coupler 260 and the second coupler 270 are not limited to the pin shape, and any shape capable of mutually fixing the above components is possible. In addition, the first coupler 260 and the second coupler 270 are shown as having a structure that may be completely separated from the adjustable nozzle mount 200, but according to an embodiment, they may have an integrated structure whose position may be changed.

FIG. 14 is a drawing illustrating the process of adjusting the spraying angle by the rotation of the first nozzle portion 210, the second nozzle portion 220, and the nozzle coupling 230 in the nozzle module according to an embodiment. If FIG. 14, the X axis may correspond to an axis extending in the length direction of the module body 110.

FIGS. 14(a), (b), and (c) illustrate the process in FIG. 13(c) and FIG. 13(d) and show the view of the second nozzle portion 220 so that the nozzle 212 is visible in the axis R direction shown on FIG. 13(d).

FIG. 14(a) shows the first coupler 260 and the second coupler 270 being separated, since the first coupler 260 is separated, as shown in FIG. 13(c), the movement of the guiding portion 214 is possible. As the guiding portion 214 moves along the direction of the shown arrow, the direction in which the nozzle 212 fixed to the guiding portion 214 and the discharging path 132 disposed inside the discharging path are oriented may be adjusted, thereby adjusting the spraying angle.

FIG. 14(a) is an embodiment in which the guiding portion 214 is oriented in the z-y plane and the spraying angle may be adjusted by rotating the nozzle 212 in the z-y plane (e.g., about an axis parallel to the x axis). The guiding portion 214 has the shape of a band arranged in the middle of the sphere shape and is a structure that is movable by being placed on a plane parallel to the z-y plane. This refers to FIG. 10 and FIG. 11.

FIG. 14(b) shows a shape in which the first coupler 260 is coupled to the sawtooth shape of the guiding portion 214 through the nozzle coupling 230 and the position of the nozzle 212 disposed on the guiding portion 214 is fixed by fixing the guiding portion 214 to the nozzle coupling 230.

In the drawing shown in FIG. 14(b), since the first coupler 260 is coupled, the connection portion 240 may appear to be fixed, but as shown in FIG. 13(d), the first coupler 260 does not overlap the connection portion 240 and does not play a role in fixing the position of the connection portion 240.

FIG. 14(b) shows the state in which the second coupler 270 is separated and the nozzle coupling 230 and the connection portion 240 are separated. FIG. 14(b) shows a state in which the nozzle coupling 230 may be rotated along the direction of the arrow with the respect to an axis parallel to the y-axis.

Referring to the shape of the rotation with the axis (R) as a reference in FIG. 13(d), when rotating the nozzle coupling 230, the second nozzle portion 220, which has the spherical shape fixed to the nozzle coupling 230, rotates with the nozzle coupling 230 with respect to the axis R. At this time, the guiding portion 214 fixed to the second nozzle portion 220 and the nozzle 212 fixed to the guiding portion 214 rotate together, and the direction that the discharging path 132 disposed inside the nozzle 212 is directed is changed to adjust the spraying angle.

FIG. 14(c) is a configuration in which the spraying angle is adjusted by rotating the nozzle coupling 230 along the direction of the arrow shown in FIG. 14(b) and then the nozzle coupling 230 and the connection portion 240 are fixed by combining the second coupler 270 to fix the spraying angle.

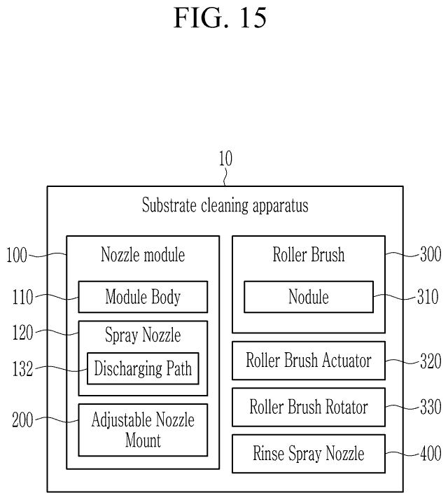

FIG. 15 is a view shown to illustrate a configuration of a substrate cleaning apparatus according to an embodiment.

As shown in FIG. 15, a substrate cleaning apparatus 10 according to the present disclosure may include a pair of roller brushes 300, a pair of nozzle modules 100, and a rinse spray nozzle 400. The roller brushes 300 are each respectively positioned over opposing surfaces of substrate 1. Each of the nozzle modules 100 are arranged with a longitudinal length in parallel with an axis of each roller brush 300 of the pair of roller brushes 300. Each of the nozzle modules 100 is spaced by a certain distance from a respective roller brush 300 and is configured to spray chemicals on the respective roller brush 300. The rinse spray nozzle 400 is configured to spray a rinse solution towards the opposing surfaces of the substrate 1.

The nozzle module 100 of the substrate cleaning apparatus 10 may include a pair of module bodies 110, a plurality of spray nozzles 120 for each module body 110, and a plurality of adjustable nozzle mounts 200 for each module body. The modules bodies are arranged side by side with each module body spaced apart from a respective roller brush 300 by a certain distance. Each of the adjustable nozzle mounts 200 couples a respective spray nozzle 120 to a respective one of the module bodies 110. Each of the spray nozzles 120 is configured to spray chemicals on a respective one of the pair of roller brushes 300. The adjustable nozzle mounts control the spraying angle of the spray nozzle 120. The adjustable nozzle mount 200 is characterized by being configured to enable the adjustment of the spraying angle of the spray nozzle 120 to change how the chemical is applied from the spray nozzles on each respective roller brush 300 so that the chemical can be evenly applied to the nodule 310 surface on each roller brush 300.

The spray nozzle 120 may be rotated around a first direction, which is the length direction of the module body 110, and may be rotated around the second direction, which is perpendicular to the first direction. The adjustable nozzle mount 200 may further include a nozzle coupling 230 that fixes the spray nozzle 120 in a position after the spray nozzle 120 is rotated to a selected angle.

The spray nozzle 120 may include a nozzle 212 with a discharging path 132 that is connected to a flow path 112 of the module body 110 through which the chemical flows inside the module body 110 at a first end and a second end opposite the first end may be arranged to face the roller brush 300.

According to the present disclosure, the substrate cleaning apparatus 10 may further include a roller brush actuator 320 that moves each roller brush 300. For example, the roller brush actuator 320 may move each roller brush 300 between a first position that is near the substrate 1 and a second position that is near the nozzle module 100. The roller brush actuator 320 may be a motor or other drive configured to move the roller brush.

Additionally, the substrate cleaning apparatus may further include a roller brush rotator 330. The roller brush rotator 330 may rotate each roller brush 300 around a longitudinal axis, which may be parallel to the length direction of each roller brush 300. For example, the roller brush rotator may be a motor configured to rotate the brush about its axis.

The rinse spray nozzle 400 is configured to spray a rinse solution toward one or both of the opposing surfaces of the substrate 1.

In the cleaning process of the substrate 1 according to the present disclosure using the nozzle module 100, the substrate cleaning apparatus 10 including the nozzle module 100, and the substrate cleaning method using the same, the substrate 1 may be cleaned in both a horizontal type in which the substrate 1 is placed horizontally with respect to gravity as well as a vertical type in which the substrate 1 is placed vertically with respect to gravity.

The substrate cleaning apparatus 10 including the nozzle module 100 and the substrate cleaning method using the same according to the present disclosure is a technology to efficiently control the etch rate of films sensitive to etching chemicals in the conventional cleaning process (the post cleaning) that is performed after the polishing process and has the advantage of eliminating the need for a separate dilution device by spraying the chemical on the roller brush 300 rather than the substrate 1.

In addition, by adjusting the spraying angle of the chemical sprayed on the roller brush 300, the chemical is evenly and thinly applied to the roller brush 300, thereby finely controlling the etch rate and improving the etching uniformity.

The substrate cleaning apparatus 10 including the nozzle module 100 and the substrate cleaning method using the same according to the present disclosure efficiently controls the etch rate of films sensitive to etching chemicals, but the types of the films used are not limited to the films with high etch rates, and all films used in the semiconductor CMP process, including oxide, SiN, W, Cu, or low-k film materials may be targeted.

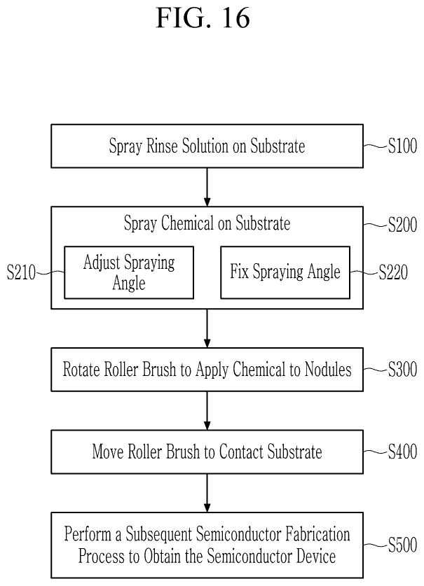

FIG. 16 illustrates a method of manufacturing a semiconductor device according to some embodiments. The method of manufacturing a semiconductor device may include cleaning the substrate 1 using the substrate cleaning apparatus 10 according to the present disclosure. The method may include a step (S100) in which the rinse spray nozzle 400 sprays the rinse solution on a surface of the substrate 1, a step (S200) in which the nozzle module 100, which is arranged side by side and spaced apart from the roller brush 300 sprays the chemical on the roller brush 300, a step (S300) in which the roller brush 300 rotates with the length direction of the roller brush 300 as the axis to apply the chemical to the plurality of nodules 310 arranged on the surface of the roller brush 300, a step (S400) in which the roller brush 300 moves close to the surface of the substrate 1 and cleans the surface of the substrate 1, and a step (S500) of performing a subsequent semiconductor fabrication process to obtain the semiconductor device.

Spraying (S200) the chemical through the nozzle module 100 may include adjusting (S210) the spraying angle of the spray nozzle 120 through the adjustable nozzle mount 200 to ensure that the chemical is evenly applied to the surface of the nodule 310 disposed on the roller brush 300.

Also, fixing (S220) the spraying angle of the spray nozzle 120 through the adjustable nozzle mount 200 may be further included.

In the process of replacing the roller brush 300 of a consumable, when the nozzle module 100 is touched the direction toward which the spray nozzle 120 is oriented may change and there is a problem in that the spraying direction of the chemical sprayed on the roller brush 300 becomes different. This causes the inconvenience of having to reset the spraying angle of the moved spray nozzle 120. In the method of cleaning the substrate 1 by using the substrate cleaning apparatus 10 according to the present disclosure, the adjustable nozzle mount 200 may fix the spraying angle of the spray nozzle 120, thereby an optimal spraying angle may be maintained. That is, by further including fixing (S220) the spraying angle of the spray nozzle 120 through the adjustable nozzle mount 200, the inconvenience of re-configuring the same profile may be omitted and the time required to re-configure may be shortened.

Performing (S500) a subsequent semiconductor fabrication process to obtain the semiconductor device may include performing conventional semiconductor manufacturing processes such as etching to remove material and deposition to add material to the substrate. In some examples, other semiconductor fabrication processes may be performed prior to spraying (S100) the rinse solution on the substrate. For example, cleaning the substrate 1 using the substrate cleaning apparatus 10 may be performed between fabrication processes.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A nozzle module comprising:
a module body extending in a first direction and configured to be spaced apart from an object by a particular distance, wherein the object is configured to clean a substrate;
a spray nozzle configured to spray a chemical on the object; and
an adjustable nozzle mount that is coupled to the module body and selectively fixes the spray nozzle in a selectable orientation, wherein the adjustable nozzle mount controls an orientation of the spray nozzle to adjust a spraying angle of the spray nozzle.

2. The nozzle module of claim 1, wherein:
the spray nozzle is one of a plurality of spray nozzles, where each of the spray nozzles of the plurality of spray nozzles is positioned on the module body along a length direction of the module body.

3. The nozzle module of claim 2, wherein:
the adjustable nozzle mount is one of a plurality of adjustable nozzle mounts, wherein each of the adjustable nozzle mounts of the plurality of adjustable nozzle mounts is coupled to a respective one of the spray nozzles of the plurality of spray nozzles, and
each of the adjustable nozzle mounts of the plurality of the adjustable nozzle mounts independently controls the spraying angle of a respective one of the spray nozzles of the plurality of adjustable nozzle mounts.

4. The nozzle module of claim 1, wherein:
the spray nozzle is rotatable around a first axis that is parallel to a length direction of the module body and is rotatable around a second axis that is perpendicular to the first axis.

5. The nozzle module of claim 4, wherein:
the adjustable nozzle mount further includes a nozzle coupling that fixes the spray nozzle in a set orientation.

6. The nozzle module of claim 1, wherein:
the spray nozzle has a discharging path passing therethrough and a nozzle;
a first end of the discharging path is connected to a flow path in the module body in which the chemical inside the module body moves; and
a second end of the discharging path exits the nozzle, which is oriented to face the object.

7. The nozzle module of claim 6, wherein:
the nozzle is configured to spray the chemical as a fog spray or a straight line spray dependent on an area of a cross-section of the discharging path in the nozzle.

8. The nozzle module of claim 6, wherein:
the spray nozzle includes:
a first nozzle portion, including the discharging path in a tube shape and a guiding portion in a band shape coupled to the nozzle, wherein the nozzle moves as the guiding portion rotates along a circumference of the band shape; and
a second nozzle portion coupled to the guiding portion so that the first nozzle portion is exposed, wherein the second nozzle portion and the band shape of the first nozzle portion together form a spherical shape; and
the adjustable nozzle mount includes:
a nozzle coupling that is rotatable with reference to a rotation axis perpendicular to a length direction of the module body while being coupled with the second nozzle portion; and
a connection portion having a first end coupled to the nozzle coupling and a second end opposite to the first end coupled to the module body and the connection portion extending along the rotation axis from the first end to the second end.

9. The nozzle module of claim 8, wherein:
the nozzle coupling has a partial spherical cavity; and
the second nozzle portion is located within the partial spherical cavity and the nozzle extends from the partial spherical cavity such that the discharging path is directed outward through the nozzle.

10. The nozzle module of claim 8, further comprising:
an external housing that surrounds the first nozzle portion, the second nozzle portion, the nozzle coupling, and the connection portion so that parts of the first nozzle portion and the second nozzle portion are exposed.

11. The nozzle module of claim 8, further comprising:
a first coupler coupled to the guiding portion of the first nozzle portion and the nozzle coupling and fixing the guiding portion to the nozzle coupling to fix a position of the nozzle.

12. The nozzle module of claim 11, further comprising:
a second coupler coupled to the nozzle coupling and the connection portion and fixing the nozzle coupling to the connection portion to fix the position of the second nozzle portion coupled to the nozzle coupling.

13. A substrate cleaning apparatus comprising:
a pair of roller brushes that are each spaced apart from one another by a distance greater than a thickness of a substrate to be cleaned;
a pair of nozzle modules spaced apart from one another with the pair of roller brushes therebetween, each of the nozzle modules configured to spray a chemical onto an adjacent roller brush of the pair; and
a rinse spray nozzle configured to spray a rinse solution towards a plane between the pair of roller brushes.

14. The substrate cleaning apparatus of claim 13, further comprising:
a roller brush actuator configured to move each roller brush between a first position and a second position, wherein the second position is farther from a respective nozzle module than the first position.

15. The substrate cleaning apparatus of claim 13, further comprising:
a roller brush rotator configured to rotate each roller brush about a longitudinal axis of a respective roller brush.

16. The substrate cleaning apparatus of claim 13, wherein:
each of the nozzle modules includes:
a pair of module bodies, each module body having a long axis parallel to one another and spaced apart from each roller brush by a first distance;
a spray nozzle mounted on each module body of the pair of module bodies and configured to spray a chemical on a respective roller brush of the pair; and
an adjustable nozzle mount coupled with the spray nozzle and configured to control a spraying angle of the spray nozzle, and
wherein the adjustable nozzle mount is configurable to control the spraying angle of the spray nozzle to apply the chemical evenly to a nodule surface on each roller brush.

17. The substrate cleaning apparatus of claim 16, wherein:
the spray nozzle is rotatable around an axis parallel to a first direction that is a length direction of the pair of module bodies and is rotatable around a second direction perpendicular to the first direction; and
the adjustable nozzle mount further includes a nozzle coupling portion that fixes a position of the spray nozzle.

18. A method of manufacturing a semiconductor device, the method comprising:
spraying a rinse solution on a surface of a substrate;
spraying a chemical on a roller brush by a nozzle module arranged side by side with the roller brush and spaced from the roller brush by a certain distance;
rotating the roller brush about an axis parallel to a length direction of the roller brush so that the chemical is applied to a plurality of nodules arranged on a surface of the roller brush;
cleaning the surface of the substrate by moving the roller brush to be close to the surface of the substrate; and
performing at least one subsequent semiconductor fabrication process to obtain the semiconductor device.

19. The method of claim 18, wherein:
spraying the chemical by the nozzle module includes controlling a spraying angle of a spray nozzle by an adjustable nozzle mount so that the chemical is evenly applied to a surface of a nodule on the roller brush.

20. The method of claim 19, further comprising:
fixing the spraying angle of the spray nozzle by the adjustable nozzle mount.
